(19) United States
(12) Patent Application Publication
(10) Pub. No.: US 2026/0222312 A1
(43) Pub. Date: Jul. 30, 2026

(54) TECHNIQUES FOR GRADIENT SCALING IN FEDERATED LEARNING

(71) Applicant: QUALCOMM Incorporated, San Diego, CA (US)

(72) Inventors: Amit MOSES, Tel Aviv (IL); Ronen SHAKED, Kfar Saba (IL); Gideon Shlomo KUTZ, Ramat Hasharon (IL); Yuval BEN HUR, Nesher (IL); Evgeny LEVITAN, Haifa (IL); Ariel Yaakov SAGI, Haifa (IL); Reuven ALPERT, Givat Ada (IL); Aviv REGEV, Tel Aviv (IL)

(21) Appl. No.: 19/039,021

(22) Filed: Jan. 28, 2025

(51) Int. Cl. H04L 41/16; G06N 3/098; H04W 24/02

(52) U.S. Cl. CPC H04L 41/16; G06N 3/098; H04W 24/02

(57) ABSTRACT

Certain aspects of the present disclosure provide techniques for wireless communications. An example method includes identifying a first value for a scaling factor associated with scaling a gradient indication, wherein the gradient indication is associated with communicating gradient information for federated learning at the UE; transmitting, to a network entity, the first value; receiving, from the network entity, a second value for the scaling factor; and transmitting, to the network entity, the gradient indication using the second value for the scaling factor.

### INTRODUCTION

### Field of the Disclosure

Aspects of the present disclosure relate to wireless communications, and more particularly, to techniques for gradient signaling power scaling in federated learning.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method of wireless communication by a user equipment (UE). The method includes identifying a first value for a scaling factor associated with scaling a gradient indication, wherein the gradient indication is associated with communicating gradient information for federated learning at the UE; transmitting, to a network entity, the first value; receiving, from the network entity, a second value for the scaling factor; and transmitting, to the network entity, the gradient indication using the second value for the scaling factor.

Certain aspects provide a method of wireless communication by a network entity. The method includes receiving a first value for a scaling factor associated with scaling a gradient indication, wherein the gradient indication is associated with communicating gradient information for federated learning at a set of nodes; transmitting, to the set of nodes, a second value for the scaling factor; and receiving, from the set of nodes, the gradient indication using the second value for the scaling factor.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 is a diagram of an example environment associated with federated learning.

FIG. 6 is a diagram illustrating an example resource configuration for gradient signaling.

FIG. 7 is a diagram illustrating an example of gradient scaling based on a scaling factor.

FIG. 8 is a diagram illustrating an example of signaling for gradient scaling.

FIG. 9 depicts a method for wireless communications.

FIG. 10 depicts aspects of an example communications device.

### DETAILED DESCRIPTION

Aspects of the present disclosure provide apparatuses, methods, processing systems, and computer-readable mediums for gradient scaling in federated learning.

A UE operating in a network may utilize a machine learning component for any number of different types of operations, transmissions, user experience enhancements, and/or the like. For example, in some cases, a UE may use one or more machine learning components to report, to a base station, information associated with received signals, user interactions with the UE, and/or positioning information, among other examples. For example, a UE may perform measurements associated with reference signals and use one or more machine learning components to facilitate reporting the measurements to a base station. In some examples, the UE may measure reference signals during a beam management process for channel state feedback (CSF), may measure received power of reference signals from a serving cell and/or neighbor cells, may measure signal strength of inter-radio access technology (e.g., WiFi) networks, may measure sensor signals for detecting locations of one or more objects within an environment, and/or the like. In some examples, a UE may use one or more machine learning components to use data associated with a user's interaction with the UE to customize or otherwise enhance a user experience with a user interface.

A machine learning component is a component (e.g., hardware, software, or a combination thereof) of a device (e.g., a client device, a server device, a UE, a base station, etc.) that performs one or more machine learning procedures. A machine learning component may include, for example, hardware and/or software that may learn to perform a procedure without being explicitly trained to perform the procedure. A machine learning component may include, for example, a feature learning processing block and/or a representation learning processing block. A machine learning component may include one or more neural networks. A neural network may include, for example, an autoencoder.

In some cases, machine learning components may be trained using federated learning. Federated learning is a machine learning technique that enables multiple clients to collaboratively train machine learning models based on training data, while the server device does not collect the training data from the client devices. Federated learning techniques may involve one or more global neural network models trained from data stored on multiple client devices (e.g., UEs).

In federated learning, various nodes (e.g., UEs) determine and report model parameters to a network entity (e.g., gNB, training server, etc.). The network entity may combine the model parameters, such as by averaging the model parameters or the like, to determine a selected value for the model parameters. The network entity may send the selected value for the model parameters back to the UEs. This process may be repeated until convergence is obtained. The model parameters may include, for example, weights of a model, biases of a model, gradients that indicate a change in a model parameter, or the like.

In some cases, model parameters can be reported as physical layer signaling (e.g., rather than a data transmission that includes data that indicates the model parameters). For example, a node may transmit an analog signal that represents a model parameter (e.g., a signal in a first resource or with a first configuration may represent a first value of the model parameter, a signal in a second resource or with a second configuration may represent a second value of the model parameter, and so on). The network entity may receive a signal that comprises a sum of all the analog signals transmitted by the set of nodes. Thus, the model parameters are combined “over the air” in a process referred to as “over-the-air (OTA) averaging”. OTA averaging may reduce overhead relative to data-based transmission of model parameters since all nodes of a set of nodes can transmit the model parameters on the same set of resources. In the context of gradient signaling, for k nodes (e.g., UEs), a gradient \hat{θ}ᵢ may be signaled by each of the k nodes for i=0 . . . k, and a received channel Y at the network entity may be received as

$$Y = {\sum }_{i = 1}^{K} {\hat{θ}}_{i} + n ,$$

where n is noise.

Wireless channels typically have some amount of interference, attenuation, clusters, and so on. This can lead to a first analog signal for OTA transmission being received at a different strength than a second analog signal for OTA transmission due to channel characteristics (where the channel at a subcarrier n is represented by and referred to as a channel matrix hₙ). To mitigate the effects of the channel hₙ the set of nodes (and the network entity) may apply pre-equalization to the analog signals. When applying pre-equalization, the averaged model parameter, for a jth model parameter, can be denoted as

$${w}_{j} = {\sum }_{n} {h}_{n} ( {h}_{n}^{- 1} {w}_{j , n} ) , where {h}_{n}^{- {1}_{\approx }}$$

denotes an inverse of the channel matrix (including phase information). This pre-equalization using the inverse of the channel matrix is achievable when channel reciprocity is applicable, since the nodes (e.g., UEs) can estimate the uplink channel from a received downlink signal.

Though OTA averaging (also referred to as OTA aggregation) is beneficial for model parameter signaling, several factors can lead to degradation of the signaling of the model parameters. One such factor is quantization error. Quantization error is the error introduce by a transmitter's digital-to-audio converter (DAC) because of a finite resolution of the DAC. The quantization error is the difference between the generated/transmitted analog signal and the closest available digital value at each sampling instance (e.g., from the analog-to-digital converter). Furthermore, in the context of gradient signaling, the gradient tends to become smaller with each epoch in the federated learning process. Thus, it becomes increasingly more difficult to quantize their value, since each epoch's gradient values span over a smaller and smaller amplitude. Hence, gradient values may be observed to converge to the same value (zero). Thus, if left untreated, a node may transmit the gradient value as zero instead of the gradient's true value, which is too small to be differentiated from zero on account of quantization error. One way to tackle this issue is to increase the number of bits in the DAC. However, higher bit-depth DACs are more complex to design and manufacture, which can significantly increase cost. Higher bit-depth DACs also lead to higher power consumption, which might non-ideal for portable devices.

Aspects of the present disclosure relate generally to addressing quantization error in gradient signaling for federated learning. Some aspects more specifically provide selection and a signaling of a scaling factor for a plurality of nodes (e.g., UEs) participating in federated learning. For example, the scaling factor may be applied by each node to a gradient value before converting the gradient value to an analog signal for transmission. By applying the scaling factor to the gradient value, a situation where information is lost due to quantization error relating to diminishing gradient values is avoided. For example, gradient values that are converging on zero may be scaled to larger values which are not subject to so great a degree of quantization error. The receiver (e.g., network entity) may descale the gradient values according to the scaling factor, thereby achieving scaling and descaling of the gradient values and improving accuracy of gradient signaling. By improving accuracy of gradient signaling, the rate of convergence of federated learning is increased and overhead associated with signaling additional gradient values for additional epochs is eliminated.

In some aspects, the scaling factor may be a global scaling factor. For example, the selected value for the scaling factor may be used by all nodes of the plurality of nodes. Thus, the network entity can apply descaling that is common to all nodes of the plurality of nodes, reducing processor and memory usage relative to maintaining individual scaling factors for each node of the plurality of nodes.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

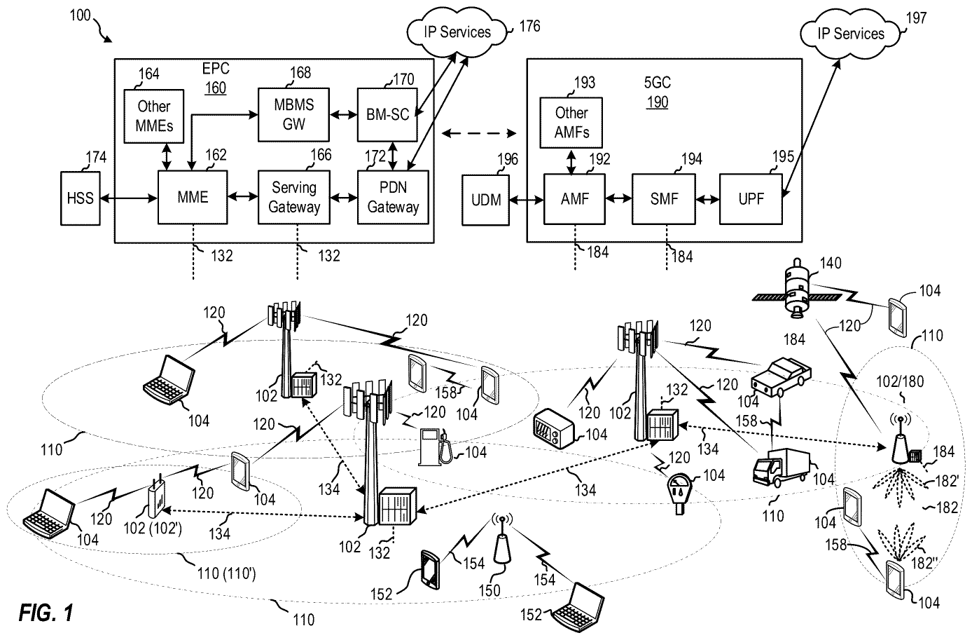

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

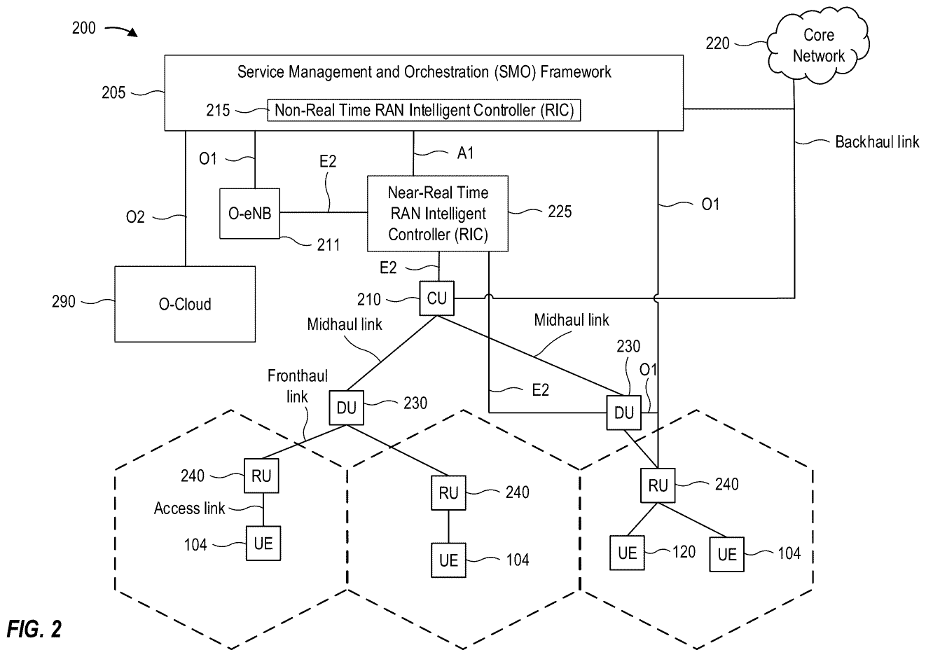

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

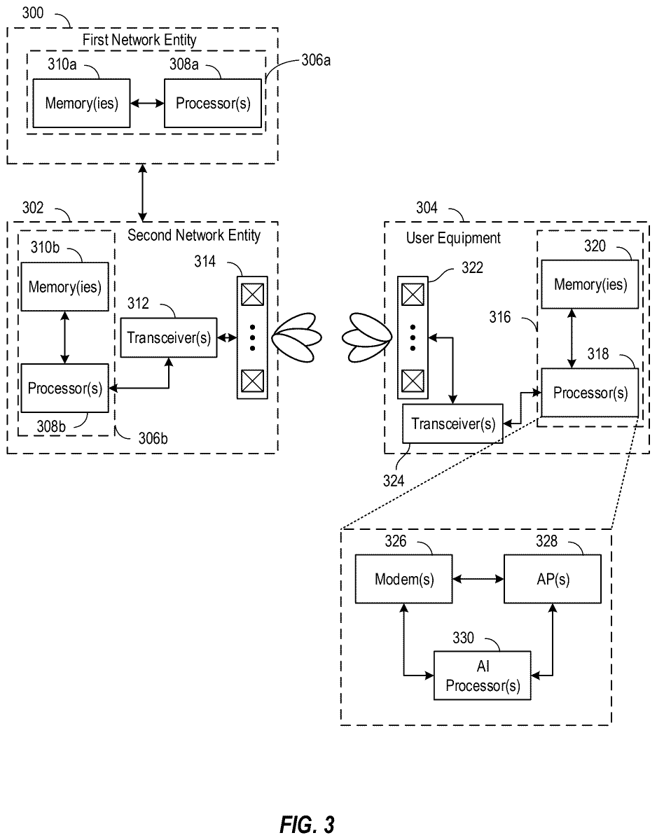

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

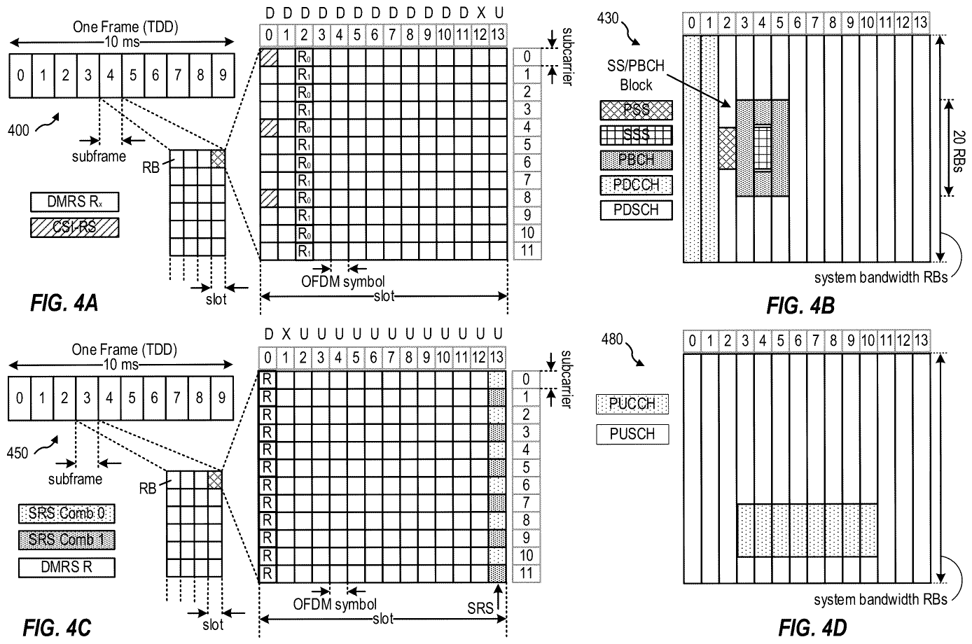

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

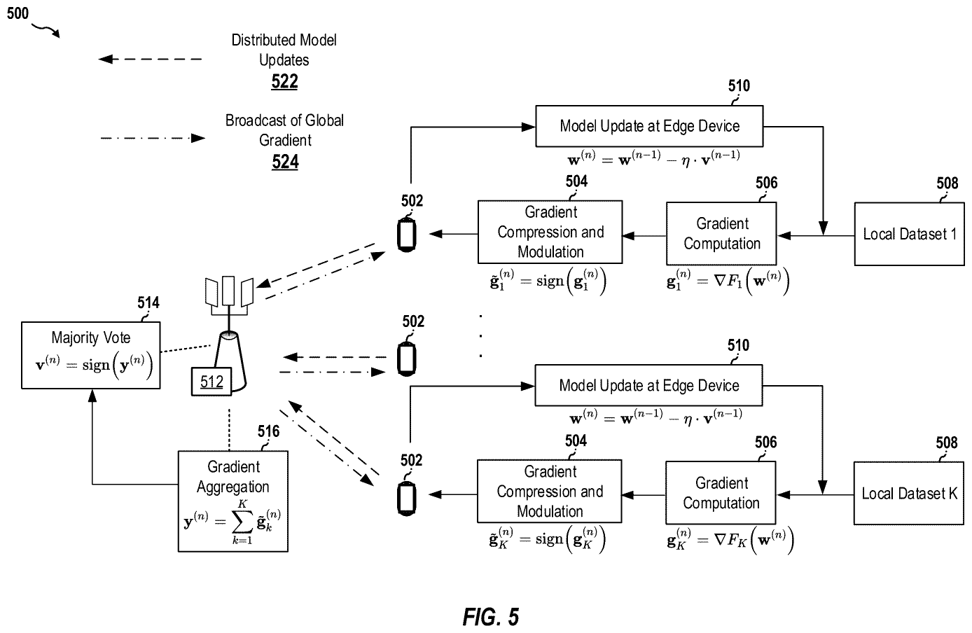

FIG. 5 is a diagram of an example environment 500 associated with federated learning according to one or more aspects. The parameter server 512 (also referred to as an edge server) may correspond to the BS 102, the first network entity 300, the second network entity 302, or an element of a disaggregated RAN described with regard to FIG. 2. The edge device 502 may correspond to the UE 104 or 304. An edge device 502 may be referred to herein as a node, and a parameter server 512 may be referred to herein as a network entity.

Federated learning is a technique that may enable users (e.g., UEs or edge devices) to train a ML model (e.g., a neural network) in a collaborative and distributed fashion using users' local datasets at edge devices (e.g., nodes). Specifically, in each round, the parameter server 512 may select a number of edge devices 502, and may transmit 524 a copy of the global ML model (e.g., the copy may include the parameters (weights) or a gradient set of the global ML model) to each of the selected edge devices 502. Then, at 506, each edge device 502 may compute updated local model parameters or gradients (or gradient set elements) of the ML model based on a local copy of the ML model (which may be referred to as the local ML model hereinafter) that is updated, at 510, with the local dataset 508 at the edge device 502. At 504, each edge device 502 may compress and/or modulate the computed local gradients (or gradient set elements) in preparation for transmission. Next, each edge device 502 may feedback, at 522, the corresponding update including the updated local model parameters or the local gradient set elements to the parameter server 512. Thereafter, the parameter server 512 may aggregate, at 516, all the updates 522 from the edge devices 502, and may update, at 514, the global ML model based on the aggregated updates and a majority vote. For the next iteration/round, the parameter server 512 may transmit a copy of the updated global machine model (e.g., parameters (weights) or a global gradient set) to selected edge devices 502, and the edge devices 502 may perform again similar operations as described above. The process may be repeated for a number of times corresponding to a number of iterations/rounds until the global ML model converges (e.g., until the global model update may no longer produce any non-negligible changes to the global ML model).

Federated learning may be associated with the advantage of keeping user data (e.g., local dataset 508) private at edge devices 502 based on the distributed optimization framework (i.e., the user data itself may not be transmitted to the parameter server 512).

Below is description of an approach by which a majority vote can be used, in conjunction with sign indications, to perform the federated learning. Aspects described herein are not limited to cases involving majority voting and sign indications, and can be applied for other forms of gradient signaling, such as signaling of a full gradient.

In one or more configurations, the federated learning, in particular, the gradient update and aggregation, may be performed using a “signSGD” approach. For the federated learning, in communication round n, the k-th UE may calculate the gradient,

$${w}_{k}^{( n )} ,$$

based on a subset of the local dataset of the k-th UE, and may send the gradient to the network (e.g., the parameter server). For the OTA federated learning, multiple nodes may share the same resources for transmitting their gradients. In particular, each UE may transmit

$$\frac{{w}_{k}^{( n )}}{{h}_{k}^{( n )}} , where {h}_{k}^{( n )}$$

may be the channel coefficient of the resource (referred to as channel pre-compensation). Of course, there may be different schemes for the channel pre-compensation at the UE (e.g., zero forcing, minimum mean square error (MMSE), etc.).

In one or more configurations, the received signal at the parameter server at the n-th communication round may be given as follows:

$${r}^{( n )} = {\sum }_{k = 1}^{K} {h}_{k}^{( n )} \frac{{w}_{k}^{( n )}}{{h}_{k}^{( n )}} = {\sum }_{k = 1}^{K} {w}_{k}^{( n )} .$$

For the OTA federated learning, gradient combining may be performed OTA utilizing the superposition property of the wireless channel. Due to the channel pre-compensation, the gradients may be coherently combined. The network (e.g., the parameter server) may be interested just in the sum of the local gradients. Hence, there may be no need to resolve the interference between the gradients transmitted by the different nodes. In fact, the interference may be utilized to accumulate the gradients.

In one or more configurations, instead of sending the actual gradients, the nodes may implement the “signSGD” approach. In particular, with the “signSGD” approach, a node may send just the sign of the gradient instead of the actual gradient. The “signSGD” approach may be associated with efficient compression of the gradient transmission. Accordingly, use of the “signSGD” approach may lead to reduction of transmission overhead while maintaining a high convergence rate.

Accordingly, in one or more configurations, the gradient combining for the federated learning may be performed in a non-coherent fashion. In particular, all UEs may simultaneously transmit the signs of respective gradients using a non-coherent orthogonal modulation scheme using two resources: l⁺ and l⁻. The transmitted symbols t_{k,l}_{⁺} and t_{k,l}_{^{−}} may be given as follows:

$$\begin{matrix}{t}_{k , {l}^{+}} = \{ \begin{matrix}\sqrt{{p}_{k}} \times {s}_{k , i}^{( n )} , & when {w}_{k , i}^{( n )} \geq 0 \\ 0 , & when {w}_{k , i}^{( n )} < 0\end{matrix} , \\ {t}_{k , {l}^{-}} = \{ \begin{matrix}0 , & when {w}_{k , i}^{( n )} \geq 0 \\ \sqrt{{p}_{k}} \times {s}_{k , i}^{( n )} , & when {w}_{k , i}^{( n )} < 0\end{matrix} , \\ where {s}_{k , i}^{( n )}\end{matrix}$$

may be a (pseudo-)random symbol on a unit circle, and may be independent (different) across resources and UEs, pₖ may be the power of the transmitted symbol, i may represent the gradient index, and l may represent the time-frequency resource index.

Accordingly, at the network (e.g., the parameter server), the received superimposed (superposed) compressed gradients on the pair of resources may be given as follows:

$$\begin{matrix}{r}_{{l}^{+}}^{( n )} = {\sum }_{∀ k} \sqrt{{p}_{k}} {h}_{k , {l}^{+}}^{( n )} + {n}_{{l}^{+}}^{( n )} , \\ {r}_{{l}^{-}}^{( n )} = {\sum }_{∀ k} \sqrt{{p}_{k}} {h}_{k , {l}^{-}}^{( n )} + {n}_{{l}^{-}}^{( n )} ,\end{matrix}$$

In some configurations, the channel phase may be random. Further, it may be assumed that the UEs may not have the channel phase information to perform channel pre-compensation.

In one or more configurations, the received power on both resources l⁺ and l⁻ may be accumulated. The average power of the received signals on the two resources may be given as follows:

$$\begin{matrix}E [ {r}_{{l}^{+}}^{( n )} {r}_{{l}^{+}}^{{( n )}^{*}} ] = {\sum }_{∀ {k}_{∈ {K}^{{+}^{( n )}}}} {p}_{k} + {σ}^{2} , \\ E [ {r}_{{l}^{-}}^{( n )} {r}_{{l}^{-}}^{{( n )}^{*}} ] = {\sum }_{∀ {k}_{∈ {K}^{{-}^{( n )}}}} {p}_{k} + {σ}^{2}\end{matrix}$$

where K⁺^{⁽ⁿ⁾} and K⁻^{⁽ⁿ⁾} may be the set (list) of UEs voting for positive and negative gradients, respectively, in the n-th communication round, and σ² may be the noise power. The small scale fading channel coefficients

$${h}_{k , {l}^{+}}^{( n )} and {h}_{k , {l}^{-}}^{( n )}$$

may be averaged out, since

$$E \{ {\vert {h}_{k , {l}^{+}}^{( n )} \vert}^{2} \} = E \{ {\vert {h}_{k , {l}^{-}}^{( n )} \vert}^{2} \} = 1.$$

In one or more configurations, the same gradient may be transmitted over multiple resources to achieve sufficient channel averaging. The majority vote may then be given as follows:

$${v}_{i}^{( n )} = sign ( {\vert {r}_{{l}^{+}}^{( n )} \vert}_{2}^{2} - {\vert {r}_{{l}^{-}}^{( n )} \vert}_{2}^{2} ) .$$

Next, the majority vote may be used to update the global training parameters. Thereafter, the parameter server may share the updated global training parameters (e.g., weights) with the UEs.

In one or more configurations, the network (e.g., the parameter server) may be configured to enable the non-coherent combining of the local gradients without channel pre-compensation. To that end, the network may configure UEs participating in the federated learning (training) to send the local gradient updates (which may be referred to simply as gradients) using a non-coherent orthogonal modulation scheme. An example non-coherent orthogonal modulation schemes have been described in detail above. In particular, the network may configure the UEs to transmit indications of the signs of the local gradients using the “signSGD” approach, instead of sending the actual gradients. In one or more configurations, the network may configure the UEs with the non-coherent orthogonal modulation scheme via one or more of an RRC message, a MAC-control element (MAC-CE), a system information (SI) message, or a DCI message.

As part of a federated learning process for an ML model, such as an artificial neural network, parameters affecting the functioning of artificial neurons and layers of the ML model may be adjusted. For example, backpropagation techniques may be used to train the ML model by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

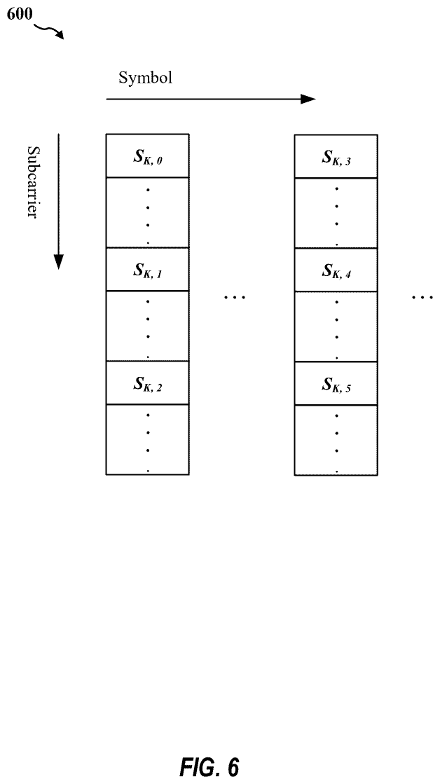

FIG. 6 is a diagram 600 illustrating an example resource configuration for gradient signaling. In one or more configurations, the network (e.g., the parameter server) may configure the resources that the nodes may use to transmit gradient updates using the non-coherent orthogonal modulation scheme. As shown in FIG. 6, the resource configuration for the non-coherent orthogonal modulation scheme may include one or more of a time (e.g., slots, symbols) configuration, a frequency (e.g., RBs, REs in an RB) configuration, and/or a beam (e.g., a quasi co-location (QCL) relationship) configuration.

Unlike for pulse-amplitude modulation (PAM) or quadrature amplitude modulation (QAM), for the non-coherent orthogonal modulation scheme, the network (e.g., the parameter server) may configure a pair of resources (e.g., l⁺ and l⁻) for the gradient transmissions from the nodes. The network may then compare the received signals (e.g., received power) on the pair of resources to decode the majority vote of all participating nodes. In one or more further configurations, the network may configure multiple resources for the same gradient transmission (i.e., multiple resources for indications of positive/non-negative gradients and/or multiple resources for indications of negative/non-positive gradients) to achieve sufficient channel averaging.

In one or more configurations, the network (e.g., the parameter server) may configure the resources for the gradient transmissions from nodes taking into consideration fairness between the pair of resources associated with the non-coherent orthogonal modulation scheme. As described above, each symbol in the non-coherent orthogonal modulation scheme may be transmitted by one or more UEs using a pair of resources. It may be desired to achieve fairness between the received power in the pair of resources associated with the non-coherent orthogonal modulation scheme. In one or more configurations, for each node, the pair of resources may be configured with the same QCL properties to achieve fairness between the received power levels on these resources. That is, the node may not receive different QCL properties or different power configurations for the pair of resources associated with the non-coherent orthogonal modulation scheme. In one or more configurations, the pair of resources associated with the non-coherent orthogonal modulation scheme may be configured on the same component carrier (CC) and/or the same BWP to achieve fair comparison between the received power levels in the pair of resources. For example, the l⁺ and l⁻ resources may be on different REs on the same RB, or may be adjacent (or nearby) symbols. In general, the pair of resources associated with the non-coherent orthogonal modulation scheme may be located on nearby REs on the time-frequency grid so that the pair of resources may be associated with similar channel properties.

In one or more configurations, the network (e.g., the parameter server) may configure the resource mapping (e.g., parameters associated with resource mapping) in the non-coherent modulation scheme. Each node participating in the federated learning may send one or more gradients (or a compressed version of the gradients, e.g., using the “signSGD” approach) to the network. A mapping may be defined between the gradients and the resources. For example, the mapping may start with gradients of the inner (or outer) layers of the neural network, and then may move to the outer (or inner) layers. In such an order, the gradients may be mapped one by one to the resources in the time frequency grid. As such, the gradients may be mapped to the configured resources. For another example, for each gradient, the mapping may start with the l⁺ (or l⁻) resource first, and then may be followed by the l⁻ (or l⁺) resource. In some configurations, l⁺ may be mapped to the even-indexed resources and l⁻ may be mapped to the odd-indexed resources. In some other configurations, l⁺ may be mapped to the odd-indexed resources and l⁻ may be mapped to the even-indexed resources. In one or more configurations, the network (e.g., the parameter server) may adjust/change the resource mapping configuration (e.g., resource mapping parameters) using one or more of an RRC message, a MAC-CE, an SI message, or a DCI message.

Aspects described herein provide for nodes (e.g., UEs) and the network (e.g., parameter server, network entity) to use a scaling factor to scale and descale gradient values for OTA transmission.

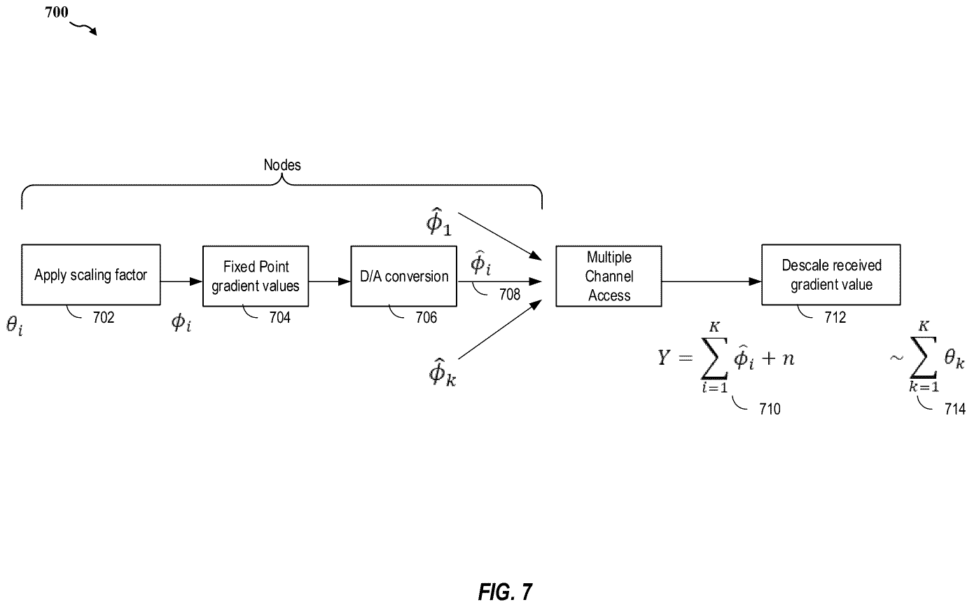

FIG. 7 is a diagram illustrating an example 700 of gradient scaling based on a scaling factor.

As shown at 702, a set of nodes (e.g., UEs) may apply a scaling factor to a gradient value. A gradient value is a value that indicates a change in a model parameter (such as a weight or a bias) based on a round (e.g., epoch) of federated learning. The set of nodes may adaptively scale the gradient values before transmitting the gradient values OTA. Thus, the gradient values may be more compatible with a dynamic range of each node's DAC than unscaled gradient values, thereby reducing the loss of resolution due to quantization error. The scaling factor for a node i is denoted θᵢ, and there are k nodes.

At 704, a scaled gradient value is represented, for example, in a fixed point representation prior to digital-to-analog (D/A) conversion at respective DACs of the set of nodes. A fixed point representation for a node i is denoted φᵢ. At 706, the set of nodes perform D/A conversion on the set of gradient values to obtain a set of analog signals. An analog signal for a node i is denoted \hat{φ}ᵢ. As shown, at 708, the set of nodes transmit the respective set of analog signals for the network entity. For example, the set of nodes may transmit the set of analog signals on resources scheduled or dedicated for indication of gradient values.

As shown at 710, the network entity may receive a signal Y as

$$Y = {\sum }_{i = 1}^{K} {\hat{ϕ}}_{i} + n .$$

The network entity may obtain a combined gradient value, for example, by performing OTA averaging as described elsewhere herein. As shown at 712, the network entity may apply the scaling factor to the combined gradient value to obtain a descaled combined gradient value. For example, the network entity may use a same scaling factor as the set of nodes. If the set of nodes multiply the gradient values by the scaling factor, the network entity may divide the combined gradient value by the scaling factor to obtain the descaled combined gradient value. As shown at 714, the descaled combined gradient value is denoted

$$\sim {\sum }_{k = 1}^{K} {θ}_{k} ,$$

indicating that the descaled combined gradient value is approximately the sum of the scaling factors of the nodes 1 through k.

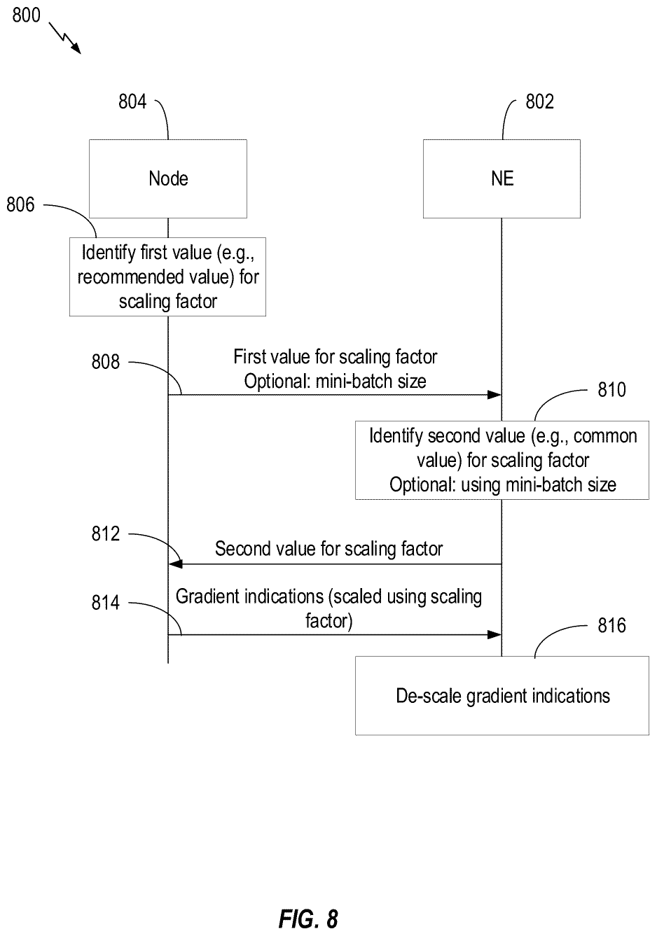

FIG. 8 is a diagram illustrating an example 800 of signaling for gradient scaling. Example 800 includes a network entity 802 and a node 804. Network entity 802 may be an example of BS 102, first network entity 300, second network entity 302, an element of a disaggregated RAN, or a parameter server 512. Node 804 may be an example of UE 104, UE 304, or an edge device 502.

Example 800 is described with regard to a single node 804 for clarity. However, it should be understood that operations described as being performed by the node (including transmission operations, reception operations, and identification operations) may be performed by each of a set of nodes that include the node 804.

At 806, the node 804 (e.g., set of nodes) identifies a first value for a scaling factor for a gradient value. In some aspects, the node 804 may identify the first value for the scaling factor based on a mini-batch. A mini-batch is a subset of training data, such as a set of training data specific to a node 804 or a set of training data specific to a set of frequencies. For example, the first value may be identified as (e.g., using) an average power of the gradient value (e.g., an average magnitude of the gradient value) after the gradient value is computed for the mini-batch. In some aspects, the node 804 may identify the first value based on a dynamic range of a DAC of the node 804. For example, the node 804 may identify a first value that causes the gradient value, when converted to an analog signal, to not saturate the DAC or to fall within a desired range of the dynamic range of the DAC.

The node 804 may identify the gradient value as part of federated learning. For example, the node 804 may determine a set of model parameters (e.g., weights and/or biases) for an ML model based on an AI/ML training technique, such as backpropagation to minimize a loss function as described in connection with FIG. 5. The node 804 may generate a gradient value that indicates a change in the set of model parameters, for example, relative to a prior iteration of the set of parameters. In some aspects, the gradient indication may be based on a mini-batch, meaning that the training data used to determine the set of model parameters is a subset of available training data.

At 808, the node 804 (e.g., set of nodes) transmits, and the network entity 802 receives, the first value. For example, the node 804 may transmit the first value via MAC signaling (e.g., a MAC CE) (for example, if the first value is sent once per federated learning procedure). As another example, the node 804 may transmit the first value via a physical uplink control channel (PUCCH) (for example, if the first value is sent once per epoch or mini-batch, which may reduce overhead of each transmission of the first value).

In some aspects, the node 804 periodically transmits the first value. For example, the first value may be specific to an epoch, and the node 804 may identify (at 806) and transmit (at 808) the first value once per epoch. In such examples, the first value may be derived from an average power of the gradient in the epoch. An epoch represents one complete pass of the entire dataset through the neural network. In the context of federated learning, a round of distributed model training may involve only a subset of the dataset available to all users. Once all the samples in the dataset have been used, an epoch is completed. In some aspects, the node 804 transmits the first value once per mini-batch. For example, the first value may be specific to a mini-batch. In such examples, the first value may be derived from an average power of the gradient in the mini-batch.

As shown, in some aspects, at 808 (or separately from the signaling at 808), the node 804 may transmit, and the network entity 802 may receive, an indication of a mini-batch size. A mini-batch size may indicate an amount of data (e.g., a number of subcarriers, a number of gradient values, or the like) belonging to a mini-batch. In some aspects, different nodes may have non-uniform data sizes for the federated learning, leading to non-uniform mini-batch sizes. In such examples, the network entity 802 may determine a second value (e.g., global value) for the scaling factor using the indication(s) of the mini-batch size. For example, the network entity 802 may determine the second value as a weighted average of first values received from the set of nodes, where weighting of the weighted average is according to respective mini-batch sizes of the set of nodes (e.g., a node with a larger mini-batch size may be afforded a higher weight). In some aspects, the node 804 may transmit the indication of the mini-batch size periodically. Additionally, or alternatively, the node 804 may transmit the indication of the mini-batch size based on a change in the mini-batch size.

As shown, at 810, the network entity 802 identifies a second value for the scaling factor. The second value may be referred to as a global value of the scaling factor, since the second value may apply to (e.g., be used by) each node of the set of nodes including the node 804. At 812, the network entity 802 transmits, and the node 804 (e.g., set of nodes) receives, the second value. For example, the network entity 802 may transmit the second value via a MAC CE. As another example, the network entity 802 may broadcast the second value (e.g., to the set of nodes). In some aspects (when the set of nodes report first values per epoch), the second value may be specific to an epoch (and/or may be transmitted once per epoch). In some aspects (when the set of nodes report first values per mini-batch), the second value may be specific to a mini-batch (and/or may be transmitted once per mini-batch).

In some aspects, the network entity 802 identifies the second value for the scaling factor by performing a combination of (e.g., averaging or weighted averaging) each first value received from each of the set of nodes, which strikes a balance between DAC saturation and quantization error. In some aspects, the network entity 802 identifies the second value for the scaling factor by using a minimum first value (indicating a smallest scaling of the gradient indication) of first values reported by the set of nodes as the second value, which reduces the occurrence of saturation of DACs of the set of nodes. In some other aspects, the network entity 802 identifies the second value for the scaling factor by using a maximum first value (indicating a largest scaling of the gradient indication) of first values reported by the set of nodes as the second value, which minimizes the impact of quantization error.

As shown, at 814, the node 804 (e.g., set of nodes) transmits, and the network entity 802 receives, one or more gradient indications using the scaling factor. For example, the node 804 may scale the one or more gradient indications using the scaling factor, as described in connection with FIG. 7. In some aspects, the node 804 may scale and transmit a gradient indication associated with a particular mini-batch or epoch using a scaling factor specific to that mini-batch or epoch. The one or more gradient indications may be associated with communicating gradient information for the federated learning. The gradient information includes the gradient value(s) determined by the set of nodes.

As shown, at 816, the network entity 802 de-scales the gradient indication(s) using the scaling factor, as described in connection with FIG. 7. In some aspects, the network entity 802 may de-scale a gradient indication associated with a particular mini-batch or epoch using a scaling factor specific to that mini-batch or epoch. The network entity 802 may update an ML model based on the gradient indication(s). For example, the network entity 802 may identify an averaged gradient value from the gradient indication(s) and may update a corresponding model parameter in accordance with the averaged gradient value. The network entity 802 may provide an indication of the averaged gradient value to the set of nodes including the node 804, and the set of nodes may repeat the operations of FIG. 8. In some aspects, the set of nodes may continue to use the originally-indicated second value (e.g., global scaling factor). In some other aspects, the set of nodes may identify and signal updated first values (e.g., recommended scaling factors) which the network entity 802 may use to identify an updated second value (e.g., global scaling factor).

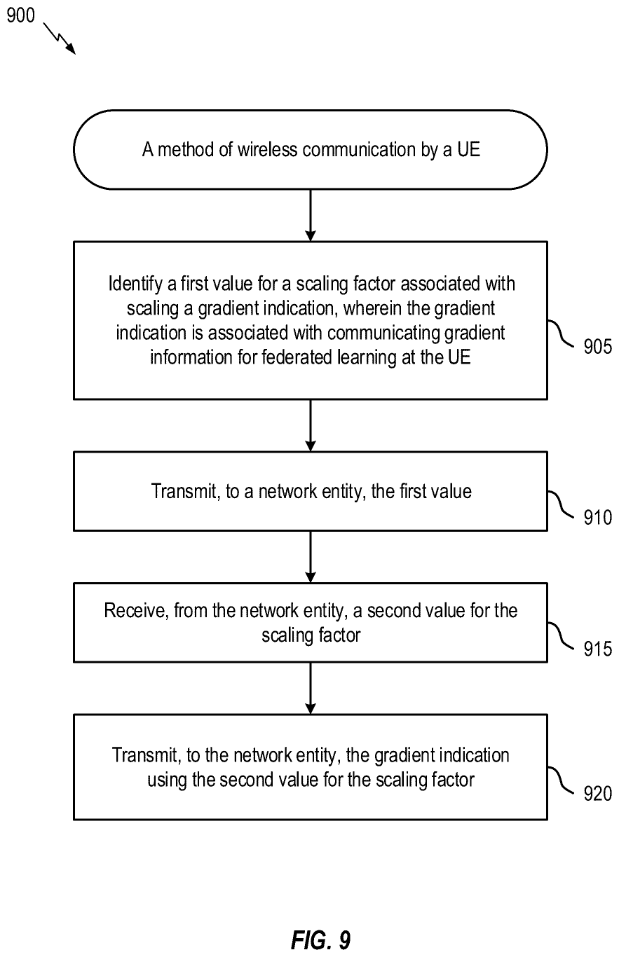

FIG. 9 shows a method 900 for wireless communication by a node, such as UE 104 of FIG. 1, UE 304 of FIG. 3, or edge device 502.

By applying the scaling factor to the gradient value, a situation where information is lost due to quantization error relating to diminishing gradient values is avoided. For example, gradient values that are converging on zero may be scaled to larger values which are not subject to so great a degree of quantization error. The receiver (e.g., network entity) may descale the gradient values according to the scaling factor, thereby achieving scaling and descaling of the gradient values and improving accuracy of gradient signaling. By improving accuracy of gradient signaling, the rate of convergence of federated learning is increased and overhead associated with signaling additional gradient values for additional epochs is eliminated.

In some aspects, the scaling factor may be a global scaling factor. For example, the selected value for the scaling factor may be used by all nodes of the plurality of nodes. Thus, the network entity can apply descaling that is common to all nodes of the plurality of nodes, reducing processor and memory usage relative to maintaining individual scaling factors for each node of the plurality of nodes.

Method 900 begins at block 905 with identifying a first value for a scaling factor associated with scaling a gradient indication, wherein the gradient indication is associated with communicating gradient information for federated learning at the node.

Method 900 then proceeds to block 910 with transmitting, to a network entity, the first value.

Method 900 then proceeds to block 915 with receiving, from the network entity, a second value for the scaling factor.

Method 900 then proceeds to block 920 with transmitting, to the network entity, the gradient indication using the second value for the scaling factor.

In some aspects, the second value for the scaling factor is based on first values associated with a plurality of nodes including the node.

In some aspects, the second value comprises a combination of the first values.

In some aspects, the second value comprises a minimum value of the first values.

In some aspects, the second value comprises a maximum value of the first values.

In some aspects, block 910 includes transmitting the first value in association with a start of the federated learning.

In some aspects, block 910 includes transmitting the first value in accordance with a periodicity.

In some aspects, block 910 includes transmitting the first value once per epoch of the federated learning.

In some aspects, block 910 includes transmitting the first value once per mini-batch of the federated learning.

In some aspects, the second value is associated with a first epoch or a first mini-batch, and wherein the method 900 further comprises: transmitting a third value for the scaling factor, the third value associated with a second epoch or a second mini-batch; receiving a fourth value for the scaling factor, the fourth value associated with the second epoch or the second mini-batch; and transmitting a second gradient indication using the fourth value.

In some aspects, method 900 further includes transmitting an indication of a mini-batch size associated with the first value, wherein the second value is based on the indication of the mini-batch size.

In some aspects, the second value comprises a weighted combination of first values associated with a plurality of nodes, according to mini-batch sizes of the plurality of nodes.

In some aspects, identifying the first value for the scaling factor is based on a dynamic range of a digital-to-analog converter of the node, and wherein the scaling factor indicates a power scaling for the gradient indication.

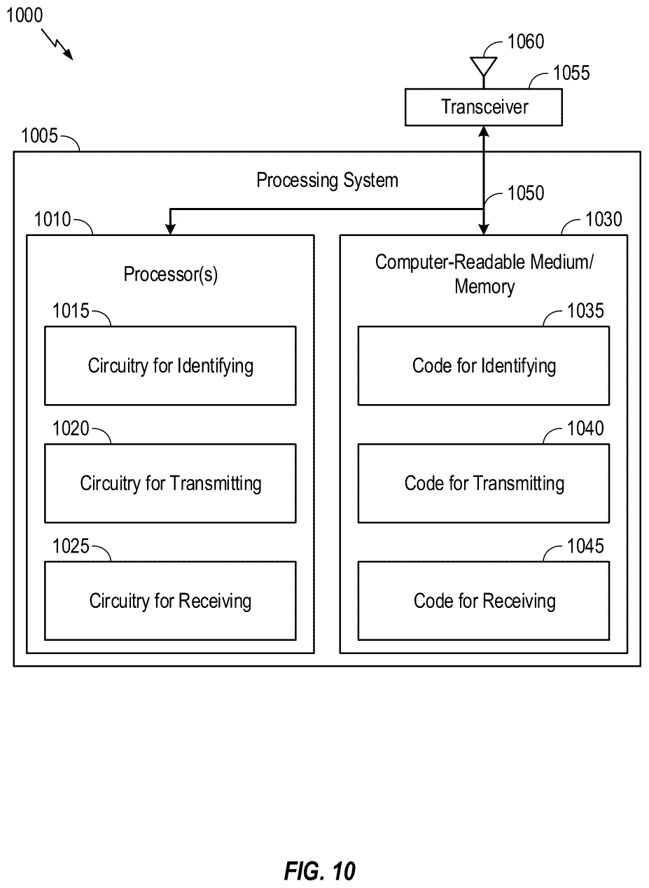

In some aspects, method 900, or any aspect related to it, may be performed by an apparatus, such as communications device 1000 of FIG. 10, which includes various components operable, configured, or adapted to perform the method 900. Communications device 1000 is described below in further detail.

Note that FIG. 9 is just one example of a method, and other methods including fewer, additional, or alternative operations are possible consistent with this disclosure.

### Example Communications Device

FIG. 10 depicts aspects of an example communications device 1000 configured for wireless communications. In some aspects, communications device 1000 is a user equipment, such as UE 104 described above with respect to FIG. 1 or UE 304 described with respect to FIG. 3.

The communications device 1000 includes a processing system 1005 coupled to a transceiver 1055 (e.g., a transmitter and/or a receiver). The transceiver 1055 is configured to transmit and receive signals for the communications device 1000 via an antenna 1060, such as the various signals as described herein. The processing system 1005 may be configured to perform processing functions for the communications device 1000, including processing signals received and/or to be transmitted by the communications device 1000.

The processing system 1005 includes one or more processors 1010 and a computer-readable medium/memory 1030. In various aspects, the one or more processors 1010 may be representative of the one or more processors 318 described with respect to FIG. 3. The one or more processors 1010 are coupled to a computer-readable medium/memory 1030 via a bus 1050. In some aspects, the computer-readable medium/memory 1030 may be representative of the one or more memories 320 described with respect to FIG. 3. The computer-readable medium/memory 1030 is a non-transitory computer-readable medium/memory. In certain aspects, the computer-readable medium/memory 1030 is configured to store instructions (e.g., computer-executable code), that when executed by the one or more processors 1010, cause the one or more processors 1010 to perform the method 900 described with respect to FIG. 9, or any aspect related to it, including any operations described in relation to FIG. 9. Note that reference to a processor performing a function of communications device 1000 may include one or more processors performing that function of communications device 1000, such as in a distributed fashion.

In the depicted example, computer-readable medium/memory 1030 stores code (e.g., executable instructions), including code for identifying 1035, code for transmitting 1040, and code for receiving 1045. Processing of the code 1035-1045 may enable and cause the communications device 1000 to perform the method 900 described with respect to FIG. 9, or any aspect related to it. For example, in some aspects, code for identifying 1035 includes code for identifying a first value for a scaling factor associated with scaling a gradient indication, wherein the gradient indication is associated with communicating gradient information for federated learning at the UE. In some aspects, code for transmitting 1040 includes code for transmitting, to a network entity, the first value. In some aspects, code for receiving 1045 includes code for receiving, from the network entity, a second value for the scaling factor. In some aspects, code for transmitting 1040 includes code for transmitting, to the network entity, the gradient indication using the second value for the scaling factor.

The one or more processors 1010 include circuitry configured to implement (e.g., execute) the code stored in the computer-readable medium/memory 1030, including circuitry for identifying 1015, circuitry for transmitting 1020, and circuitry for receiving 1025. Processing with circuitry 1015-1025 may enable and cause the communications device 1000 to perform the method 900 described with respect to FIG. 9, or any aspect related to it. For example, in some aspects, circuitry for identifying 1015 includes circuitry for identifying a first value for a scaling factor associated with scaling a gradient indication, wherein the gradient indication is associated with communicating gradient information for federated learning at the UE. In some aspects, circuitry for transmitting 1020 includes circuitry for transmitting, to a network entity, the first value. In some aspects, circuitry for receiving 1025 includes circuitry for receiving, from the network entity, a second value for the scaling factor. In some aspects, circuitry for transmitting 1020 includes circuitry for transmitting, to the network entity, the gradient indication using the second value for the scaling factor.

More generally, means for communicating, transmitting, sending or outputting for transmission may include the one or more transceivers 324, one or more antenna 322 and/or processing system 316 of the UE 304 illustrated in FIG. 3, transceiver 1055 and/or antenna 1060 of the communications device 1000 in FIG. 10, and/or one or more processors 1010 of the communications device 1000 in FIG. 10. Means for communicating, receiving or obtaining may include the one or more transceivers 324, one or more antennas 322, and/or processing system 316 of the UE 304 illustrated in FIG. 3, transceiver 1055 and/or antenna 1060 of the communications device 1000 in FIG. 10, and/or one or more processors 1010 of the communications device 1000 in FIG. 10.

### Example Clauses

Implementation examples are described in the following numbered clauses:

Clause 1: A method of wireless communication by a UE, comprising: identifying a first value for a scaling factor associated with scaling a gradient indication, wherein the gradient indication is associated with communicating gradient information for federated learning at the UE; transmitting, to a network entity, the first value; receiving, from the network entity, a second value for the scaling factor; and transmitting, to the network entity, the gradient indication using the second value for the scaling factor.

Clause 2: The method of Clause 1, wherein the second value for the scaling factor is based on first values associated with a plurality of UEs including the UE.

Clause 3: The method of Clause 2, wherein the second value comprises a combination of the first values.

Clause 4: The method of Clause 2, wherein the second value comprises a minimum value of the first values.

Clause 5: The method of Clause 2, wherein the second value comprises a maximum value of the first values.

Clause 6: The method of any one of Clauses 1-5, wherein transmitting the first value comprises transmitting the first value in association with a start of the federated learning.

Clause 7: The method of any one of Clauses 1-6, wherein transmitting the first value comprises transmitting the first value in accordance with a periodicity.

Clause 8: The method of any one of Clauses 1-7, wherein transmitting the first value comprises transmitting the first value once per epoch of the federated learning.

Clause 9: The method of any one of Clauses 1-8, wherein transmitting the first value comprises transmitting the first value once per mini-batch of the federated learning.

Clause 10: The method of any one of Clauses 1-9, wherein the second value is associated with a first epoch or a first mini-batch, and wherein the method further comprises: transmitting a third value for the scaling factor, the third value associated with a second epoch or a second mini-batch; receiving a fourth value for the scaling factor, the fourth value associated with the second epoch or the second mini-batch; and transmitting a second gradient indication using the fourth value.

Clause 11: The method of any one of Clauses 1-10, further comprising: transmitting an indication of a mini-batch size associated with the first value, wherein the second value is based on the indication of the mini-batch size.

Clause 12: The method of Clause 11, wherein the second value comprises a weighted combination of first values associated with a plurality of UEs, according to mini-batch sizes of the plurality of UEs.

Clause 13: The method of any one of Clauses 1-12, wherein identifying the first value for the scaling factor is based on a dynamic range of a digital-to-analog converter of the UE, and wherein the scaling factor indicates a power scaling for the gradient indication.

Clause 14: One or more apparatuses, comprising: one or more memories comprising executable instructions; and one or more processors configured to execute the executable instructions and cause the one or more apparatuses to perform a method in accordance with any one of Clauses 1-13.

Clause 15: One or more apparatuses configured for wireless communications, comprising: one or more memories; and one or more processors, coupled to the one or more memories, configured to cause the one or more apparatuses to perform a method in accordance with any one of Clauses 1-13.

Clause 16: One or more apparatuses configured for wireless communications, comprising: one or more memories; and one or more processors, coupled to the one or more memories, configured to perform a method in accordance with any one of Clauses 1-13.

Clause 17: One or more apparatuses, comprising means for performing a method in accordance with any one of Clauses 1-13.

Clause 18: One or more non-transitory computer-readable media comprising executable instructions that, when executed by one or more processors of one or more apparatuses, cause the one or more apparatuses to perform a method in accordance with any one of Clauses 1-13.

Clause 19: One or more computer program products embodied on one or more computer-readable storage media comprising code for performing a method in accordance with any one of Clauses 1-13.

Clause 20: One or more apparatuses configured for wireless communications, comprising: a processing system that includes one or more processors and one or more memories coupled with the one or more processors, the processing system configured to cause the one or more apparatuses to perform a method in accordance with any one of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a node to:
identify a first value for a scaling factor associated with scaling a gradient indication, wherein the gradient indication is associated with communicating gradient information for federated learning at the node;
transmit, to a network entity, the first value;
receive, from the network entity, a second value for the scaling factor; and
transmit, to the network entity, the gradient indication using the second value for the scaling factor.

2. The apparatus of claim 1, wherein the second value for the scaling factor is based on first values associated with a plurality of nodes including the node.

3. The apparatus of claim 2, wherein the second value comprises a combination of the first values.

4. The apparatus of claim 2, wherein the second value comprises a minimum value of the first values.

5. The apparatus of claim 2, wherein the second value comprises a maximum value of the first values.

6. The apparatus of claim 1, wherein to cause the node to transmit the first value, the processing system is configured to cause the node to transmit the first value in association with a start of the federated learning.

7. The apparatus of claim 1, wherein to cause the node to transmit the first value, the processing system is configured to cause the node to transmit the first value in accordance with a periodicity.

8. The apparatus of claim 1, wherein to cause the node to transmit the first value, the processing system is configured to cause the node to transmit the first value once per epoch of the federated learning.

9. The apparatus of claim 1, wherein to cause the node to transmit the first value, the processing system is configured to cause the node to transmit the first value once per mini-batch of the federated learning.

10. The apparatus of claim 1, wherein the second value is associated with a first epoch or a first mini-batch, and wherein the processing system is further configured to cause the node to:
transmit a third value for the scaling factor, the third value associated with a second epoch or a second mini-batch;
receive a fourth value for the scaling factor, the fourth value associated with the second epoch or the second mini-batch; and
transmit a second gradient indication using the fourth value.

11. The apparatus of claim 1, wherein the processing system is further configured to cause the node to:
transmit an indication of a mini-batch size associated with the first value, wherein the second value is based on the indication of the mini-batch size.

12. The apparatus of claim 1, wherein the second value comprises a weighted combination of first values associated with a plurality of nodes, according to mini-batch sizes of the plurality of nodes.

13. The apparatus of claim 1, wherein identifying the first value for the scaling factor is based on a dynamic range of a digital-to-analog converter of the node, and wherein the scaling factor indicates a power scaling for the gradient indication.

14. A method of wireless communication by a node, comprising:
identifying a first value for a scaling factor associated with scaling a gradient indication, wherein the gradient indication is associated with communicating gradient information for federated learning at the node;
transmitting, to a network entity, the first value;
receiving, from the network entity, a second value for the scaling factor; and
transmitting, to the network entity, the gradient indication using the second value for the scaling factor.

15. The method of claim 14, wherein the second value for the scaling factor is based on first values associated with a plurality of nodes including the node.

16. The method of claim 15, wherein the second value comprises a combination of the first values.

17. The method of claim 15, wherein the second value comprises a minimum value of the first values.

18. The method of claim 15, wherein the second value comprises a maximum value of the first values.

19. The method of claim 15, wherein transmitting the first value comprises transmitting the first value in association with a start of the federated learning.

20. One or more non-transitory computer-readable media comprising executable instructions that, when executed by one or more processors of an apparatus, cause the apparatus to perform operations comprising:
identifying a first value for a scaling factor associated with scaling a gradient indication, wherein the gradient indication is associated with communicating gradient information for federated learning at a node;
transmitting, to a network entity, the first value;
receiving, from the network entity, a second value for the scaling factor; and
transmitting, to the network entity, the gradient indication using the second value for the scaling factor.
